(19) United States
(12) Patent Application Publication
(10) Pub. No.: US 2002/0005983 A1
(43) Pub. Date: Jan. 17, 2002

(54) Microscope stepping device

(76) Inventor: Zoltan Fekete, Edhusgatan (SE)

Correspondence Address: Samuels, Gauthier & Stevens LLP, Suite 3300, 225 Franklin Street, Boston, MA, 02110, US

(21) Appl. No.: 09/950,160

(22) Filed: Sep. 10, 2001

Related U.S. Application Data
(63) Continuation of application No. 09/704,984, filed on Nov. 2, 2000, now abandoned.
Application No. 09/704,984 is a continuation of application No. PCT/SE99/00762, filed on May 6, 1999.

(30) Foreign Application Priority Data
May 11, 1998 (SE) 9801619-9

(51) Int. Cl. G02B 21/00; G02B 21/26

(52) U.S. Cl. 359/391; 359/383; 359/393

(57) ABSTRACT

There is disclosed a microscope causing a variable-magnification optical system provided in the optical path of the microscope and having at least an optical member movable in the direction of optical axis of the optical path, to vary the magnification of the observed image of the specimen, a rotary knob for moving the optical member in the direction of optical axis, a position indicating device for indicating when the rotary knob is in a rotary position where the optical member is in a predetermined position and a varying device for varying the predetermined position.

### DESCRIPTION

1. Technical Field

The present invention relates to a microscope stepping device for a facilitated controlled reading of a microscope object.

The object of the present invention is to obtain a defined feeding of a microscope table in one or two directions to guarantee a correct reading of a microscope object.

2. Background of the Invention

At cytologic examinations cell samples taken are examined under a microscope in order to monitor possible cell changes, and thereby, a possible risk for cancer. The work at the microscope is thereby carried out in such a way that one reads the object in one direction, then moves the object by moving the microscope table one step in a direction perpendicular to first said direction and then reads the next row of the first direction.

As it has been observed cases where reported negative cytological examinations, later on has shown development of cancer, and where a supervisory control of the cytological samples show that there had been cell changes present, but that one had missed that at the first microscopic examination due to the fact that one had advanced the microscope table too much, it has been required a device by means of which one can mark or provide a correct feeding so that each part of the object is read during the microscopic examination.

A device for this purpose means that one after having read, confirms this by lowering the objective against the object covering glass and thereby applies a colour ring onto the object covering glass. The colour rings will thereby, at a correct feeding of the object covering glass. i.e., the object table, to be placed edge by edge. If not, a missed area exists at the examination. These colour rings can, however, give off its colour, run out and cover the object and create a general problem by the need for changing colour refills, correct amount of colour shall be applied through a nozzle. the colour applied shall dry quick and easy, which is not always that easily achieved. Further. the colour ring means that a later control can not be made due to the colour coverage.

SU-A-1,269,075 describes a device for fine adjustment of a microscope table, in particular for studying circuit boards, whereby a microscope table can be moved in two directions, dimensions, by means of two screw means, where one screw means comprises a screw provided with a thread, and a spring biassed ball provided in said thread to provide for a stepped movement. This device is a part of the microscope table, can not be released, or be moved to another microscope.

Thus it has been required a more simple device to guarantee a correct feeding of the microscope table. Further, such a device should not be bound to one specific microscope design, but should be able to be used at different appearing microscopes, in particular those types appearing within the hospital laboratories.

### DESCRIPTION OF THE PRESENT INVENTION

It has now surprisingly been found possible to solve this problem by means of the present invention which is characterized in that the device comprises

i) a bar provided with grooves;

ii) a releasable, spring biassed ball intended to be able to grip into said grooves;

iii) connecting means applied on one hand to one end of the bar for fixing it to a microscope table, on the other to the means carrying the spring biassed ball for connecting the same to the fixed part of the microscope.

By means of the present invention it is obtained that the device can be readily applied to different microscopes comprising a movable table and a fixed part, and obtain that the microscope table with an object put thereon, can be moved a predetermined distance, stepwise, determined by the width of the grooves and the size of the ball, whereby the stepping can be easily disconnected when so requested when other microscoping technologies are applied.

Further advantages will be apparent from the following detailed description which describes a preferred embodiment with reference to the attached drawing, however, without being restricted thereto, whereby in the drawing

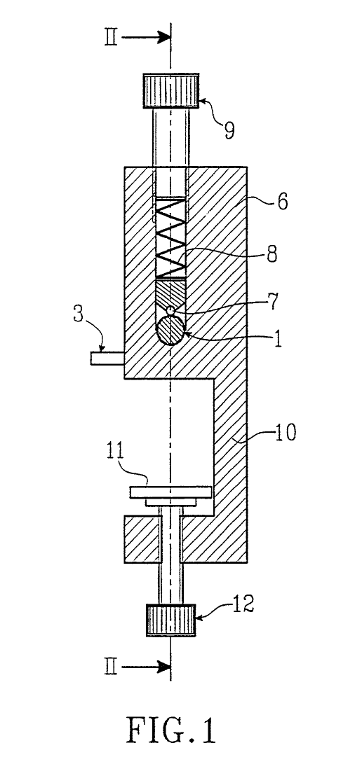

FIG. 1 shows a cross section of an embodiment of the device according to the invention;

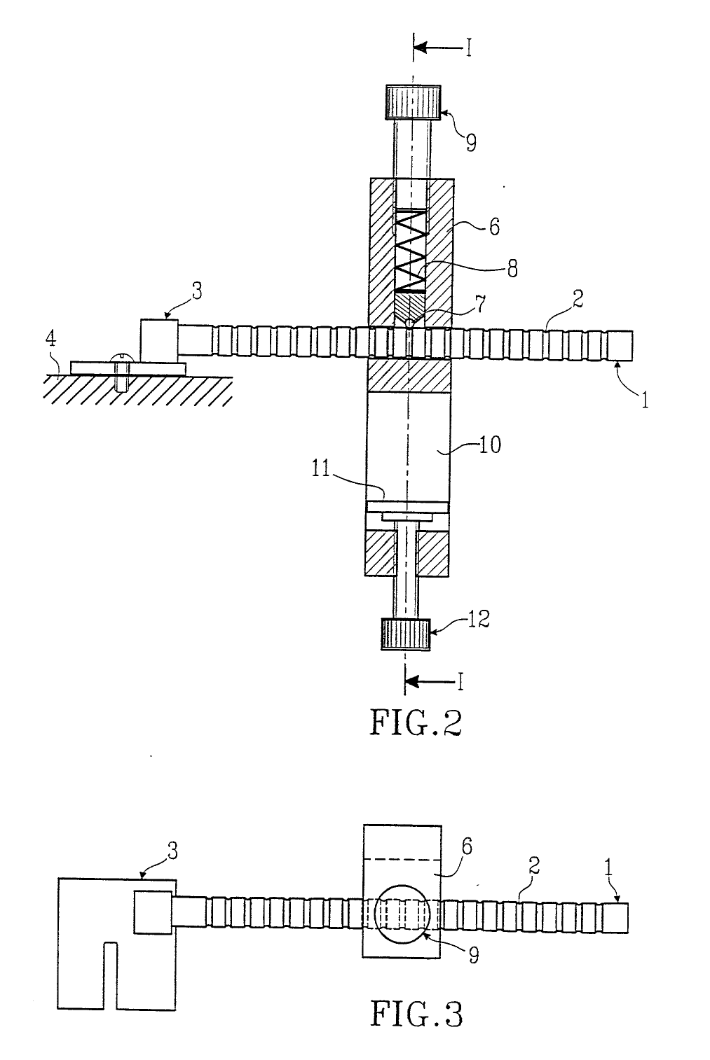

FIG. 2 shows a cross section of the device along the line II-II of FIG. 1; and

FIG. 3 shows a device of FIG. 1 seen from above.

1 denotes a bar provided with radial grooves 2. The grooves have an internal distance of 1.3 to 1.4 mm depending of the degree of coverage desired at the microscoping. The depth pf the grooves 2 extend to 0.5 to 1.0 mm. The bar 1 is in its one end provided with a hold 3 arranged to be fixed to a microscope table 4. The microscope table 4 is, in a manner known per se, arranged to be moved sidewise by means of a graduated screw (not shown) connected to the table.

The bar 1 is fixed in its end opposite hold 3 to a bearing box 6 comprising a spring biassed ball 7, a spring 8, and a release screw 9. The bearing box 6 is hereby provided with a connecting part 10 comprising a disc 11 being clampable over the table edge, which disc is controlled by means of a screw 12. The ball 7 has such a size that it does not fall into the bottom of the groove 2 but stays about halfway down into the groove 2. The bearing house 6 is further provided to be attached to the fixed part of a microscope by means of said connecting part 10, on which fixed part the microscope table is movable in two directions, perpendicular to each other on one hand using said graduated screw, on the other using a further, such screw (not shown).

The ball 7 has, as already mentioned, such a size that it goes about halfway down into the radial grooves 2. Hereby the ball 7 will, at sidewise movement of the microscope table 4 by means of the screw 5, fall into the groove 2 which on one hand will be felt by means of the touch contact through the microscope table, on the other be heard. In this way the microscope table can be moved a predetermined step (determined by the distance between the radial grooves 2/the ball 7), which means that a correct reading will be made of a whole object without loss of areas due to a too long a turning of the screw (not shown).

1. A removable stepping device to be attached to a microscope table for a facilitated controlled reading of a microscope object placed under a microscope lens, comprising:
a bar provided with grooves;
a releasable, spring biased ball that grips into and releases from said grooves;
connecting means applied to one end of the bar for fixing it to the microscope table, and to means carrying the spring biased ball for releasably connecting the same to the microscope table.
